(19) United States
(12) Patent Application Publication
(10) Pub. No.: US 2025/0385275 A1
(43) Pub. Date: Dec. 18, 2025

(54) ELECTRICALLY CONDUCTIVE MEMBER, ELECTROCHEMICAL CELL, ELECTROCHEMICAL CELL DEVICE, MODULE, AND MODULE HOUSING DEVICE

(71) Applicant: KYOCERA CORPORATION, Kyoto-shi, Kyoto (JP)

(72) Inventors: Akihiro HARA, Kirishima-shi, Kagoshima (JP); Kazuki HIRAO, Kirishima-shi, Kagoshima (JP); Atsuki YAMAGUCHI, Kirishima-shi, Kagoshima (JP); Takahiro KOMIYAMA, Kirishima-shi, Kagoshima (JP)

(21) Appl. No.: 18/879,157

(22) PCT Filed: Apr. 25, 2023
(86) PCT No.: PCT/JP2023/016270

§ 371 Date: Dec. 26, 2024

(30) Foreign Application Priority Data
Jun. 30, 2022 (JP) 2022-106506

(51) Int. Cl. H01M 8/0228; H01M 8/0206; H01M 8/0215; H01M 8/0226

(52) U.S. Cl. CPC H01M 8/0228; H01M 8/0206; H01M 8/0215; H01M 8/0226

(57) ABSTRACT

An electrically conductive member includes a base member and a polycrystalline film. The base member contains chromium. The polycrystalline film includes a plurality of chromium oxide particles and a grain boundary phase located among the plurality of chromium oxide particles, and is located on the base member. The polycrystalline film contains a first element having a first ionization energy and a free energy of formation of oxide per mole of oxygen that are smaller than those of chromium. The grain boundary phase has a content percentage of the first element that is higher than that of the plurality of chromium oxide particles.

### TECHNICAL FIELD

The present disclosure relates to an electrically conductive member, an electrochemical cell, an electrochemical cell device, a module, and a module housing device.

### BACKGROUND OF INVENTION

In recent years, various fuel cell stack devices each including a plurality of fuel cells have been proposed, as next-generation energy. A fuel cell is a type of electrochemical cell capable of obtaining electrical power by using a fuel gas such as a hydrogen-containing gas and an oxygen-containing gas such as air.

### CITATION LIST

### Patent Literature

Patent Document 1: WO 2009/131180

### SUMMARY

An electrically conductive member according to an aspect of an embodiment includes a base member and a polycrystalline film. The base member contains chromium. The polycrystalline film includes a plurality of chromium oxide particles and a grain boundary phase located among the plurality of chromium oxide particles, and is located on the base member. The polycrystalline film contains a first element having a first ionization energy and a free energy of formation of oxide per mole of oxygen that are smaller than those of chromium. The grain boundary phase has a content percentage of the first element that is higher than that of the plurality of chromium oxide particles.

An electrochemical cell of the present disclosure includes an element portion and the electrically conductive member mentioned above. The electrically conductive member is connected to the element portion.

An electrochemical cell device of the present disclosure includes a cell stack including the electrochemical cell described above.

A module of the present disclosure includes the electrochemical cell device described above and a storage container housing the electrochemical cell device.

A module housing device of the present disclosure includes the module described above, an auxiliary device that operates the module, and an external case housing the module and the auxiliary device.

### BRIEF DESCRIPTION OF THE DRAWINGS

FIG. 1A is a horizontal cross-sectional view illustrating an example of an electrochemical cell according to a first embodiment.

FIG. 1B is a side view of an example of the electrochemical cell according to the first embodiment when viewed from the side of an air electrode.

FIG. 1C is a side view of an example of the electrochemical cell according to the first embodiment when viewed from the side of an interconnector.

FIG. 2A is a perspective view illustrating an example of an electrochemical cell device according to the first embodiment.

FIG. 2B is a cross-sectional view taken along a line X-X illustrated in FIG. 2A.

FIG. 2C is a top view illustrating an example of the electrochemical cell device according to the first embodiment.

FIG. 3 is a horizontal cross-sectional view illustrating an example of an electrically conductive member according to the first embodiment.

FIG. 4A is a cross-sectional view taken along a line A-A illustrated in FIG. 3.

FIG. 4B is an enlarged view of a region B illustrated in FIG. 4A.

FIG. 4C is an enlarged view of a polycrystalline film illustrated in FIG. 4B.

FIG. 5 is an exterior perspective view illustrating an example of a module according to the first embodiment.

FIG. 6 is an exploded perspective view schematically illustrating an example of a module housing device according to the first embodiment.

FIG. 7A is a cross-sectional view illustrating an example of an electrochemical cell according to a second embodiment.

FIG. 7B is an enlarged cross-sectional view of an electrically conductive member according to the second embodiment.

FIG. 8A is a horizontal cross-sectional view illustrating an example of an electrochemical cell according to a third embodiment.

FIG. 8B is a horizontal cross-sectional view illustrating another example of the electrochemical cell according to the third embodiment.

FIG. 8C is a horizontal cross-sectional view illustrating another example of the electrochemical cell according to the third embodiment.

FIG. 8D is an enlarged view of a region C illustrated in FIG. 8A.

FIG. 9A is a perspective view illustrating an example of an electrochemical cell according to a fourth embodiment.

FIG. 9B is a partial cross-sectional view of the electrochemical cell illustrated in FIG. 9A.

FIG. 9C is a partial cross-sectional view of the electrochemical cell illustrated in FIG. 9A

### DESCRIPTION OF EMBODIMENTS

In the fuel cell stack device described above, the internal resistance of the electrically conductive member may increase, which could reduce battery performance.

It is desired to provide an electrically conductive member, an electrochemical cell, an electrochemical cell device, a module, and a module housing device, which can reduce the increase in the internal resistance.

Embodiments of an electrically conductive member, an electrochemical cell, an electrochemical cell device, a module, and a module housing device disclosed in the present application will be described in detail with reference to the accompanying drawings. Note that the disclosure is not limited by the following embodiments.

Note that the drawings are schematic and that the dimensional relationships between elements, the proportions of the elements, and the like may differ from the actual ones. There may be differences between the drawings in the dimensional relationships, proportions, and the like.

### First Embodiment

### Configuration of Electrochemical Cell

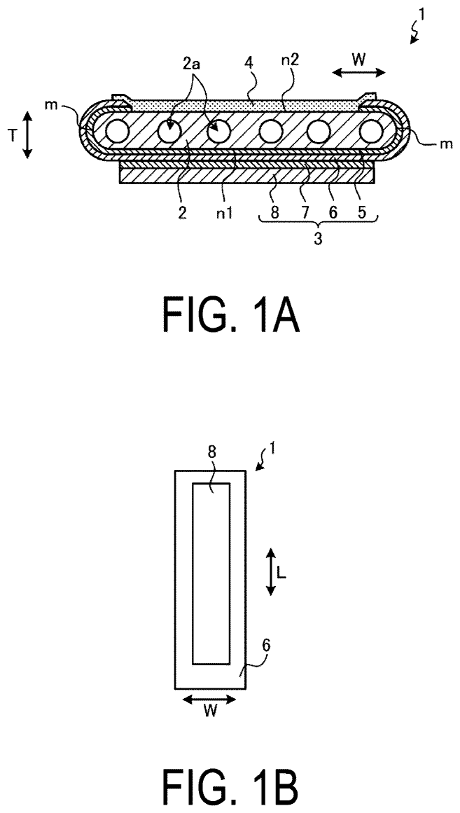

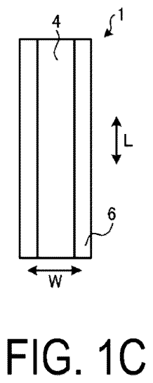

First, with reference to FIGS. 1A to 1C, an example of a solid oxide fuel cell will be described as an electrochemical cell according to a first embodiment. The electrochemical cell device may include a cell stack including a plurality of electrochemical cells. The electrochemical cell device including the plurality of electrochemical cells is simply referred to as a cell stack device.

FIG. 1A is a horizontal cross-sectional view illustrating an example of an electrochemical cell according to the first embodiment, FIG. 1B is a side view of an example of the electrochemical cell according to the first embodiment when viewed from an air electrode side, and FIG. 1C is a side view of an example of the electrochemical cell according to the first embodiment when viewed from an interconnector side. Note that FIGS. 1A to 1C are enlarged views each illustrating part of a configuration of the electrochemical cell. Hereinafter, the electrochemical cell may be simply referred to as a cell.

In the example illustrated in FIGS. 1A to 1C, a cell 1 is of a hollow flat plate type, and has an elongated plate shape. As illustrated in FIG. 1B, the shape of the entire cell 1 when viewed from the side is a rectangle having a side length of, for example, 5 cm to 50 cm in a length direction L and a length of, for example, 1 cm to 10 cm in a width direction W orthogonal to the length direction L. A thickness of the entire cell 1 in a thickness direction T is, for example, 1 mm to 5 mm.

As illustrated in FIG. 1A, the cell 1 includes a support substrate 2 with electrical conductivity, an element portion 3, and an interconnector 4. The support substrate 2 has a pillar shape having a pair of a first surface n1 and a second surface n2 facing each other, and a pair of circular arc shaped side surfaces m connecting the first surface n1 and the second surface n2.

The element portion 3 is located on the first surface n1 of the support substrate 2. The element portion 3 includes a fuel electrode 5 serving as a first electrode, a solid electrolyte layer 6, and an air electrode 8 serving as a second electrode. In the example illustrated in FIG. 1A, the interconnector 4 is located on the second surface n2 of the cell 1. Note that the cell 1 may include an intermediate layer 7 between the solid electrolyte layer 6 and the air electrode 8.

As illustrated in FIG. 1B, the air electrode 8 does not extend to the lower end of the cell 1. At the lower end portion of the cell 1, only the solid electrolyte layer 6 is exposed on a surface of the first surface n1. As illustrated in FIG. 1C, the interconnector 4 may extend to the lower end of the cell 1. At the lower end portion of the cell 1, the interconnector 4 and the solid electrolyte layer 6 are exposed on the surface. Note that, as illustrated in FIG. 1A, the solid electrolyte layer 6 is exposed at the surfaces at the pair of side surfaces m in a circular arc shape of the cell 1. The interconnector 4 need not extend to the lower end of the cell 1.

Hereinafter, each of constituent members constituting the cell 1 will be described.

The support substrate 2 includes gas-flow passages 2a, inside which gas flows. The example of the support substrate 2 illustrated in FIG. 1A includes six gas-flow passages 2a. The support substrate 2 has gas permeability, and allows the gas flowing in the gas-flow passage 2a to permeate to the fuel electrode 5. The support substrate 2 may have electrical conductivity. The support substrate 2 having electrical conductivity causes electricity generated in the element portion to be collected in the interconnector 4.

The material of the support substrate 2 includes, for example, an iron group metal component and an inorganic oxide. For example, the iron group metal component may be Ni (nickel) and/or NiO. The inorganic oxide may be, for example, a specific rare earth element oxide. The rare earth element oxide may contain, for example, one or more rare earth elements selected from Sc, Y, La, Nd, Sm, Gd, Dy, and Yb.

As the material of the fuel electrode 5, a commonly known material may be used. The fuel electrode 5 may be a porous electrically conductive ceramic containing a material having electron conductivity and a material having ion conductivity. As the electrically conductive ceramic, for example, a ceramic containing ZrO₂ in which a calcium oxide, a magnesium oxide, or a rare earth element oxide is in solid solution, and Ni and/or NiO may be used. This rare earth element oxide may contain a plurality of rare earth elements selected from, for example, Sc, Y, La, Nd, Sm, Gd, Dy, and Yb. Hereinafter, ZrO₂ in which a calcium oxide, a magnesium oxide, or a rare earth element oxide is in solid solution may be referred to as stabilized zirconia. Stabilized zirconia may include partially stabilized zirconia.

The solid electrolyte layer 6 is an electrolyte and delivers ions between the fuel electrode 5 and the air electrode 8. At the same time, the solid electrolyte layer 6 has gas blocking properties, and makes leakage of the fuel gas and the oxygen-containing gas less likely to occur.

The material of the solid electrolyte layer 6 may be, for example, ZrO₂ in which 3 mole % to 15 mole % of a rare earth element oxide is in solid solution. The rare earth element oxide may contain, for example, one or more rare earth elements selected from Sc, Y, La, Nd, Sm, Gd, Dy, and Yb. The solid electrolyte layer 6 may contain, for example, ZrO₂ in which Yb, Sc, or Gd is in solid solution, CeO₂ in which La, Nd, or Yb is in solid solution, BaZrOs in which Sc or Yb is in solid solution, or BaCeO₃ in which Sc or Yb is in solid solution.

The air electrode 8 has gas permeability. The open porosity of the air electrode 8 may be, for example, in the range of 20% to 50%, particularly in the range of 30% to 50%. The open porosity of the air electrode 8 may also be referred to as the porosity of the air electrode 8.

The material of the air electrode 8 is not particularly limited, as long as the material is one generally used for the air electrode. The material of the air electrode 8 may be, for example, an electrically conductive ceramic such as a so-called ABO₃ type perovskite oxide.

The material of the air electrode 8 may be, for example, a composite oxide in which Sr (strontium) and La (lanthanum) coexist at the A site. Examples of such a composite oxide include LaₓSr₁₋ₓCo_{y}Fe_{1-y}O₃, LaₓSr₁₋ₓMnO₃, LaₓSr₁₋ₓFeO₃, and LaₓSr₁₋ₓCoO₃. Here, x is 0<x<1, and y is 0<y<1.

When the element portion 3 includes the intermediate layer 7, the intermediate layer 7 functions as a diffusion suppression layer. When strontium (Sr) contained in the air electrode 8 diffuses into the solid electrolyte layer 6, a resistance layer of SrZrO₃ is formed in the solid electrolyte layer 6. The intermediate layer 7 makes it difficult for Sr to diffuse, thereby making it difficult for SrZrO₃ to be formed.

The material of the intermediate layer 7 is not particularly limited as long as the material is not likely to cause the diffusion of elements between the air electrode 8 and the solid electrolyte layer 6 in general. The material of the intermediate layer 7 may contain, for example, CeO₂ (cerium oxide) in which rare earth elements other than Ce (cerium) are in solid solution. As such rare earth elements, for example, Gd (gadolinium), Sm (samarium), or the like may be used.

The interconnector 4 is dense, and makes the leakage of the fuel gas flowing through the gas-flow passages 2a located inside the support substrate 2, and of the oxygen-containing gas flowing outside the support substrate 2 less likely to occur. The interconnector 4 may have a relative density of 93% or more: particularly 95% or more.

As the material of the interconnector 4, a lanthanum chromite-based perovskite oxide (LaCrO₃-based oxide), a lanthanum strontium titanium-based perovskite oxide (LaSrTiO₃-based oxide), or the like may be used. These materials have electrical conductivity, and are unlikely to be reduced and also unlikely to be oxidized even when brought into contact with a fuel gas such as a hydrogen-containing gas and an oxygen-containing gas such as air.

### Configuration of Electrochemical Cell Device

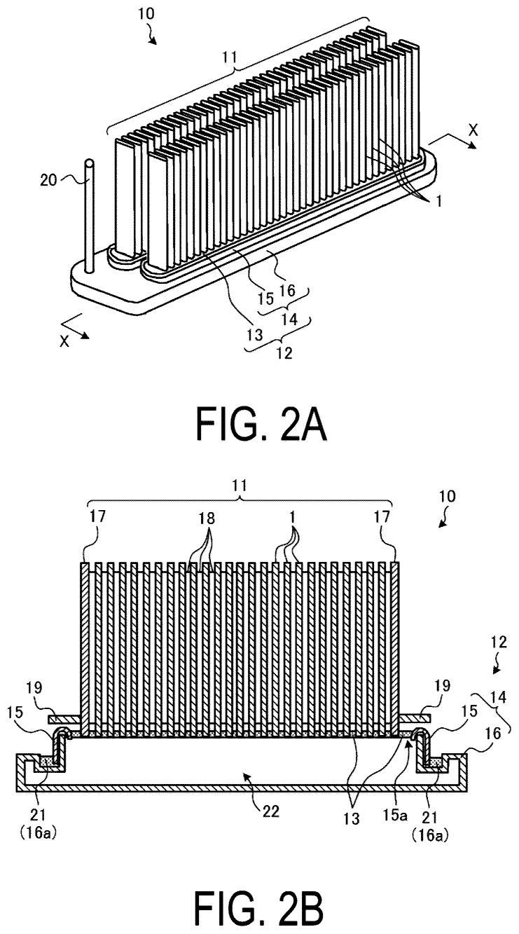

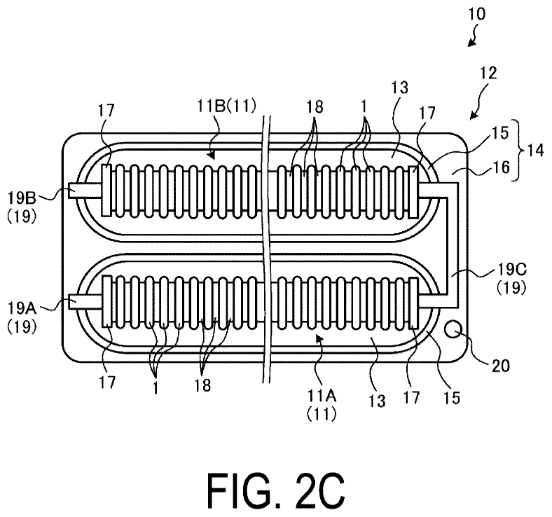

A cell stack device 10 according to the present embodiment using the cell 1 described above will be described with reference to FIGS. 2A to 2C. FIG. 2A is a perspective view illustrating an example of the electrochemical cell device according to the first embodiment, FIG. 2B is a cross-sectional view taken along a line X-X illustrated in FIG. 2A, and FIG. 2C is a top view illustrating an example of the electrochemical cell device according to the first embodiment.

As illustrated in FIG. 2A, the cell stack device 10 includes a cell stack 11 including a plurality of the cells 1 arrayed (stacked) in the thickness direction T (see FIG. 1A) of each cell 1, and a fixing member 12.

The fixing member 12 includes a fixing material 13 and a support member 14. The support member 14 supports the cells 1. The fixing material 13 fixes the cells 1 to the support member 14. The support member 14 includes a support body 15 and a gas tank 16. The support body 15 and the gas tank 16, constituting the support member 14, are made of a metal and electrically conductive.

As illustrated in FIG. 2B, the support body 15 includes an insertion hole 15a, into which the lower end portions of the plurality of cells 1 are inserted. The lower end portions of the plurality of cells 1 and the inner wall of the insertion hole 15a are bonded by the fixing material 13.

The gas tank 16 includes an opening portion through which a reactive gas is supplied to the plurality of cells 1 via the insertion hole 15a, and a recessed groove 16a located on the periphery of the opening portion. The outer peripheral end portion of the support body 15 is bonded to the gas tank 16 by a bonding material 21, with which the recessed groove 16a of the gas tank 16 is filled.

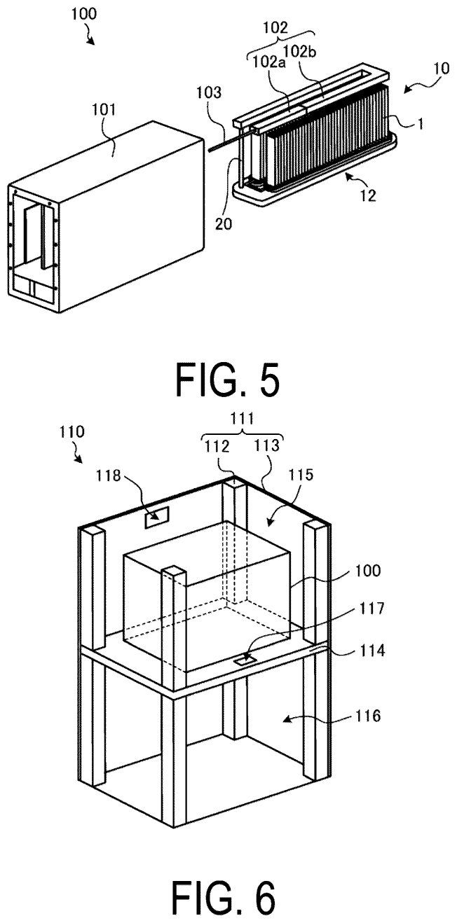

In the example illustrated in FIG. 2A, the fuel gas is stored in an internal space 22 formed by the support body 15 and the gas tank 16, constituting the support member 14. The gas tank 16 includes a gas circulation pipe 20 connected thereto. The fuel gas is supplied to the gas tank 16 through the gas circulation pipe 20 and is supplied from the gas tank 16 to the gas-flow passages 2a (see FIG. 1A) inside the cells 1. The fuel gas supplied to the gas tank 16 is produced by a reformer 102 (see FIG. 5) to be described later.

A hydrogen-rich fuel gas can be produced, for example, by steam-reforming a raw fuel. When the fuel gas is produced by steam-reforming, the fuel gas contains steam.

The example illustrated in FIG. 2A includes two rows of cell stacks 11, two support bodies 15, and the gas tank 16. The two rows of the cell stacks 11 each include the plurality of cells 1. Each of the cell stacks 11 is fixed to a corresponding one of the support bodies 15. An upper surface of the gas tank 16 includes two through holes. Each of the support bodies 15 is disposed in a corresponding one of the through holes. The internal space 22 is formed by a single gas tank 16 and two support bodies 15.

The insertion hole 15a has, for example, an oval shape in a top surface view. A length of the insertion hole 15a in an arrangement direction of the cells 1, that is, the thickness direction T, is longer than a distance between two end current collection members 17 located at both ends of the cell stack 11, for example. A width of the insertion hole 15a is, for example, greater than the length of the cell 1 in the width direction W (see FIG. 1A).

As illustrated in FIG. 2B, the joined portions between the inner wall of the insertion hole 15a and the lower end portions of the cells 1 are filled with the fixing material 13 and solidified. As a result, the inner wall of the insertion hole 15a and the lower end portions of the plurality of cells 1 are bonded and fixed, and the lower end portions of the cells 1 are bonded and fixed to each other. The gas-flow passages 2a of each of the cells 1 communicate, at the lower end portion, with the internal space 22 of the support member 14.

The fixing material 13 and the bonding material 21 may be of low electrical conductivity like glass. As the specific materials of the fixing material 13 and the bonding material 21, amorphous glass or the like may be used, and especially, crystallized glass or the like may be used.

As the crystallized glass, for example, any one selected from the group consisting of SiO₂—CaO-based, MgO—B₂O₃-based, La₂O₃—B₂O₃—MgO-based, La₂O₃—B₂O₃—ZnO-based, and SiO₂—CaO—ZnO-based materials may be used, or, in particular, an SiO₂—MgO-based material may be used.

As illustrated in FIG. 2B, electrically conductive members 18 are each interposed between the cells 1 that are adjacent to each other among the plurality of cells 1. Each of the electrically conductive members 18 electrically connects in series the fuel electrode 5 of one of the adjacent cells 1 with the air electrode 8 of the other of the adjacent cells 1. More specifically, each of the electrically conductive members 18 connects the interconnector 4 electrically connected to the fuel electrode 5 of one of the adjacent cells 1 and the air electrode 8 of the other of the adjacent cells 1. Note that the details of the electrically conductive member 18 connected between the adjacent cells 1 will be described later.

As illustrated in FIG. 2B, the end current collection members 17 are electrically connected to the cells 1 located at the outermost sides in the arrangement direction of the plurality of cells 1. The end current collection members 17 are each connected to an electrically conductive portion 19 protruding outward from the cell stack 11. The electrically conductive portion 19 collects electricity generated by the cells 1 and conducts the electricity to outside. Note that in FIG. 2A, the end current collection members 17 are not illustrated.

As illustrated in FIG. 2C, in the cell stack device 10, two cell stacks 11A and 11B, which are connected in series, function as one battery. Thus, the electrically conductive portion 19 of the cell stack device 10 is divided into a positive electrode terminal 19A, a negative electrode terminal 19B, and a connection terminal 19C.

The positive electrode terminal 19A functions as a positive electrode when the electrical power generated by the cell stack 11 is output to the outside and is electrically connected to the end current collection member 17 on a positive electrode side in the cell stack 11A. The negative electrode terminal 19B functions as a negative electrode when the electrical power generated by the cell stack 11 is output to the outside and is electrically connected to the end current collection member 17 on a negative electrode side in the cell stack 11B.

The connection terminal 19C electrically connects the end current collection member 17 on the negative electrode side in the cell stack 11A and the end current collection member 17 on the positive electrode side in the cell stack 11B.

### Details of Electrically Conductive Member

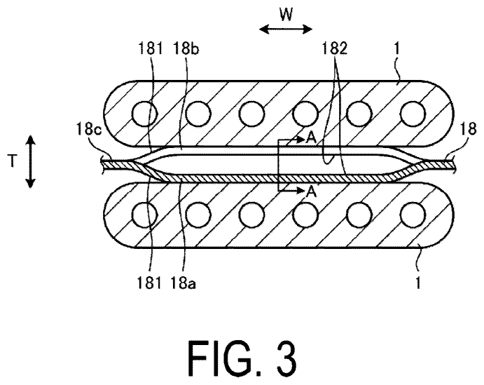

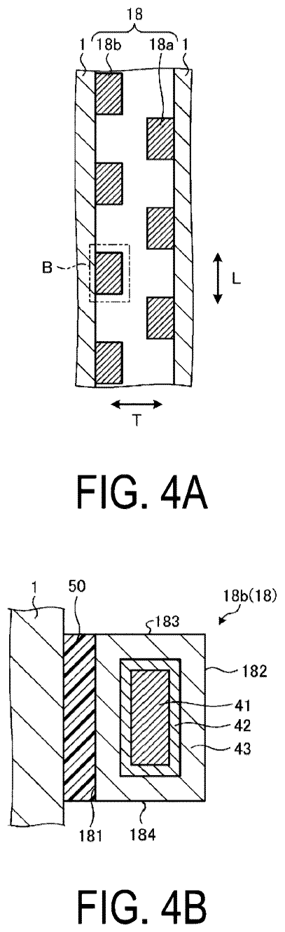

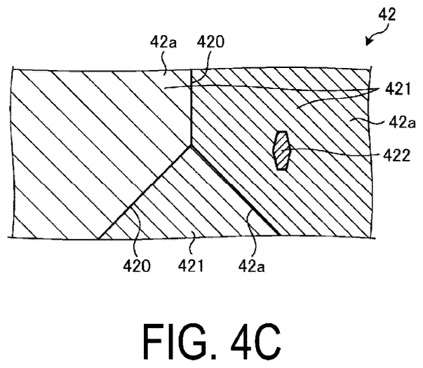

Details of the electrically conductive member 18 according to the first embodiment will be described with reference to FIG. 3 to FIG. 4C. FIG. 3 is a horizontal cross-sectional view illustrating an example of an electrically conductive member according to the first embodiment.

As illustrated in FIG. 3, the electrically conductive member 18 includes a connecting portion 18a connected to one of the adjacent cells 1 and a connecting portion 18b connected to the other of the adjacent cells 1. The electrically conductive member 18 includes coupling portions 18c at both ends in the width direction W to connect the connecting portions 18a and 18b. This enables the electrically conductive member 18 to electrically connect the cells 1 adjacent to each other in the thickness direction T. Note that in FIG. 3, the shape of each cell 1 is illustrated by simplification.

The connecting portions 18a and 18b each have a first surface 181 facing the cell 1 and a second surface 182 facing the connecting portions 18b and 18a.

FIG. 4A is a cross-sectional view taken along a line A-A illustrated in FIG. 3. FIG. 4B is an enlarged view of a region B illustrated in FIG. 4A.

The electrically conductive member 18 extends in the length direction L of the cell 1. As illustrated in FIG. 4A, a plurality of the connecting portions 18a and 18b of the electrically conductive member 18 are alternately located along the length direction L of the cell 1. The electrically conductive member 18 is in contact with the cell 1 at each of the connecting portions 18a and 18b.

As illustrated in FIG. 4B, the electrically conductive member 18 includes a base member 41, the polycrystalline film 42, and a coating layer 43. The electrically conductive member 18 has the first surface 181 and the second surface 182 located at both ends in the thickness direction T of the cell 1. The electrically conductive member 18 has third surfaces 183 and 184 that connect the first surface 181 and the second surface 182.

The electrically conductive member 18 (connecting portion 18b) is bonded to the cell 1 via a bonding material 50. The bonding material 50 is located between the first surface 181 of the electrically conductive member 18 and the cell 1, and bonds the electrically conductive member 18 and the cell 1. The second surface 182 and the third surfaces 183 and 184 are exposed to, for example, an oxidizing atmosphere such as air.

The base member 41 has electrical conductivity and thermal resistance. The base member 41 contains chromium. The base member 41 is made of, for example, stainless steel. The base member 41 may contain, for example, a metal oxide. The base member 41 may contain a first element to be described later.

FIG. 4C is an enlarged view of a polycrystalline film illustrated in FIG. 4B. The polycrystalline film 42 is located on the base member 41. The polycrystalline film 42 contains a first element 42a.

The first element 42a has a first ionization energy and a free energy of formation of oxide per mole of oxygen that are smaller than those of chromium. Examples of the first element 42a include, for example, Y, Ce, Eu, Gd, Pr, Yb, and Zr. The free energy of formation is also called Gibbs energy of formation. The free energy of formation can be confirmed in, for example, a thermodynamic database such as “Thermodynamic Database for Nuclear Fuels and Reactor Materials”. The first element 42a may be any of Ce, Eu, Pr, and Zr, in particular.

As illustrated in FIG. 4C, the polycrystalline film 42 includes a plurality of chromium oxide particles 421 and a grain boundary phase 420. The plurality of chromium oxide particles 421 contain crystals of chromium oxide (Cr₂O₃). Since the polycrystalline film 42 includes the plurality of chromium oxide particles 421, the durability of the electrically conductive member 18 is enhanced. The chromium oxide particle 421 included in the plurality of chromium oxide particles 421 may have an average particle diameter (equivalent circle diameter) of, for example, 500 nm or less, particularly 100 nm or more and 350 nm or less. The chromium oxide particle 421 may contain a component other than chromium oxide. The chromium oxide particle 421 may be a crystal of chromium oxide (Cr₂O₃). The component other than chromium oxide contained in the chromium oxide particle 421 may be, for example, a trace amount of an impurity that does not impair the crystal structure of chromium oxide.

The plurality of chromium oxide particles 421 may include first chromium oxide particles containing the first element 42a. The content of the first element 42a in the first chromium oxide particles may be, for example, 0.1 atomic % or less. The plurality of chromium oxide particles 421 may include the chromium oxide particles 421 that do not contain the first element 42a. The first element 42a may be in solid solution in the first chromium oxide particles.

The grain boundary phase 420 is located between at least two adjacent chromium oxide particles 421. The grain boundary phase 420 is an amorphous portion having the same composition as the chromium oxide particles 421. A width of the grain boundary phase 420 may be, for example, equal to or less than 10 nm. The width of the grain boundary phase 420 is a distance between two adjacent chromium oxide particles 421. The grain boundary phase 420 may contain the first element 42a in an amount of, for example, 0.01 atomic % or more and 1.0 atomic % or less, particularly 0.05 atomic % or more and 0.3 atomic % or less.

The grain boundary phase 420 has a content percentage of the first element 42a that is higher than that of the plurality of chromium oxide particles 421. Since the diffusion rate of Cr in the grain boundary is higher than the diffusion rate of Cr in the grain, the diffusion of Cr in the base member 41 is suppressed because the grain boundary phase 420 contains the first element 42a. For example, an increase in the thickness of the polycrystalline film 42 can be suppressed even in a temperature range of not less than 600° C., furthermore not less than 1000° C., where the diffusion of Cr becomes remarkable. In other words, the polycrystalline film 42 including the grain boundary phase 420 containing the first element 42a is not prone to be increased in thickness even when exposed to a high-temperature oxidizing atmosphere for a long time. As such, for example, the internal resistance of the electrically conductive member 18 is less likely to be increased, and the degradation of the power generation performance of the cell 1 can be suppressed. The first chromium oxide particles containing the first element 42a tend to have an electrical resistivity that is higher than the chromium oxide particles 421 not containing the first element 42a. By reducing the amount of the first element 42a contained in the first chromium oxide particles, the increase in electrical resistivity of the first chromium oxide particles can be suppressed. By reducing the amount of the first chromium oxide particles contained in the polycrystalline film 42, the increase in the electrical resistivity of the polycrystalline film 42 can be suppressed.

As described above, since the content percentage of the first element 42a in the grain boundary phase 420 is higher than that of the plurality of chromium oxide particles 421, the thickness of the polycrystalline film 42 is less likely to be increased, the electrical resistivity of the plurality of chromium oxide particles 421 included in the polycrystalline film 42 is less likely to be increased, and the internal resistance of the electrically conductive member 18 is less likely to be increased. The fact that the content percentage of the first element 42a in the grain boundary phase 420 is higher than that of the plurality of chromium oxide particles 421 means that the first element 42a in the polycrystalline film 42 is segregated in the grain boundary phase to reduce the content percentage of the first element 42a in the first chromium oxide particles or to reduce the ratio of the first chromium oxide particles in the plurality of chromium oxide particles 421. The polycrystalline film 42 need not include the first chromium oxide particles containing the first element 42a.

The polycrystalline film 42 may include a first particle 422. The first particle 422 is a crystalline particle containing oxide of the first element 42a, and is different from chromium oxide (Cr₂O₃). Examples of the oxide of the first element 42a include Y₂O₃, CeO₂, EuO, Gd₂O₃, PrO₂, Yb₂O₃, and ZrO₂. The first chromium oxide particles may contain the first particle 422 therein. A trace amount of Cr may be in solid solution in the first particle 422. The first particle 422 in which a trace amount of Cr is in solid solution refers to the first particle 422 in which Cr is in solid solution to an extent that does not damage the crystal structure of the first particle 422. The first particle 422 may be located between at least two adjacent chromium oxide particles 421.

The first particle 422 may contain, for example, one or more of the first elements 42a. The first particle 422 may contain an element other than the first element 42a. The first particle 422 may contain, for example, CeO₂ in which Sm (samarium) and Gd (gadolinium) are in solid solution, or ZrO₂ in which Sc (scandium), Y (yttrium), Yb (ytterbium), and the like are in solid solution, which is so-called stabilized zirconia or partially stabilized zirconia. The first particle 422 may contain a composite oxide containing the first element 42a such as Ce₂Ti₂O₇, for example.

A particle diameter of the first particle 422 may be 1/10 or less, furthermore 1/100 or less of a particle diameter of the chromium oxide particle 421 in contact with the first particle 422 or containing the first particle 422 therein. The first particle 422 has electrical insulation properties or low electrical conductivity, and the electrical resistivity of the chromium oxide particle 421 may be increased by the first particle 422 being included therein. When the first particle 422 has such a small particle diameter, even if the polycrystalline film 42 contains the first particles 442, the electrical resistivity of the polycrystalline film 42 is less likely to be increased, and the internal resistance of the electrically conductive member 18 is less likely to be increased.

The plurality of chromium oxide particles 421 need not include the first chromium oxide particles. In other words, the first element 42a included in the polycrystalline film 42 may be detected in the grain boundary phase 420 and need not be detected inside the plurality of chromium oxide particles 421 by a measurement method to be described later.

The polycrystalline film 42 may have, for example, a flat interface with the base member 41 or a wavy interface with the base member 41 having unevenness.

The polycrystalline film 42 may contain, for example, Si. For example, when the polycrystalline film 42 has unevenness at the interface with the base member 41, the Si may be located at the tip of a protruding portion of the polycrystalline film 42 protruding toward the base member 41.

The thickness of the polycrystalline film 42 may be, for example, not less than 20 nm and not more than 10 um, furthermore not less than 200 nm and not more than 3.0 um. When the polycrystalline film 42 has such a thickness, for example, the influence of the polycrystalline film 42 on the internal resistance can be suppressed to be small, and thus the internal resistance of the electrically conductive member 18 is less likely to be increased. This can suppress the degradation in the power generation performance of the cell 1, for example.

Note that the electrically conductive member 18 may include oxide of the first element 42a located on the polycrystalline film 42. Examples of the oxide of the first element 42a may be Y₂O₃, CeO₂, EuO, Gd₂O₃, PrO₂, Yb₂O₃, and ZrO₂.

The content percentage of the first element 42a in the grain boundary phase 420 and the chromium oxide particles 421 can be obtained by performing elemental analysis at arbitrary two points using TEM-EDS in each of the grain boundary phase 420 and the inside of the chromium oxide particles 421 in contact with the grain boundary phase 420 and calculating the average values thereof. The inside of the chromium oxide particle 421 refers to a portion away from the grain boundary phase 420 by 10 nm or more. In the case where the boundary between the chromium oxide particles 421 and the grain boundary phase 420 is unclear, the elemental analysis may be performed with a portion away from a substantially center point of the contours of two adjacent chromium oxide particles 421 by 10 nm or more as the inside of the chromium oxide particles 421. In this case, the elemental analysis of the grain boundary phase 420 may be performed at the substantially center point of the contours of two adjacent chromium oxide particles 421.

The size of the first particle 422 containing the first element 42a can be confirmed, for example, by performing point analysis, line analysis, mapping, or the like of the first element 42a in the cross-section of the electrically conductive member 18 using a high angle annular dark field scanning transmission electron microscope (HAADF-STEM), a focus ion beam scanning electron microscope (FIB-SEM), or an electron probe microanalyzer (EPMA). Three points inside the chromium oxide particles 421 are subjected to elemental analysis, and particles in which the first element 42a is detected at at least one point are defined as first chromium oxide particles. Particles in which the first element 42a is not detected at any of the three points subjected to the elemental analysis are regarded as the chromium oxide particles 421 not including the first element 42a. The average thickness of the polycrystalline film 42 is obtained, for example, by performing mapping of each of chromium and oxygen in the cross section of the electrically conductive member 18 using a HAADF-STEM with an acceleration voltage of 200 kV at a magnification of one million times, measuring the thicknesses at equal to or more than 10 points of the area where chromium and oxygen are detected, and calculating the average value of the thicknesses.

The electrically conductive member 18 is obtained by forming a coating film containing the first element 42a on the surface of the base member 41 containing chromium, and heat-treating the coating film containing the first element 42a and the base member 41. The coating film containing the first element 42a may be, for example, an oxide coating film of the first element 42a. The coating film containing the first element 42a may be formed by, for example, a physical vapor deposition method such as ion assisted deposition (IAD), application of slurry containing oxide of the first element 42a, or the like. The thickness of the coating film including the first element 42a may be, for example, not less than 1 nm and not more than 300 nm. The thickness of the coating film containing the first element 42a may be not less than 5 nm and not more than 150 nm, furthermore not less than 10 nm and not more than 100 nm. The coating film containing the first element 42a may include particles containing the first element 42a, for example oxide particles of the first element 42a. The particle diameter of the particles containing the first element 42a in the coating film containing the first element 42a may be, for example, equal to or less than 100 nm, equal to or less than 10 nm, furthermore equal to or less than 1 nm. When the particles containing the first element 42a are fine particles as described above, the first element 42a is easily introduced into the polycrystalline film 42, particularly into the grain boundary phase 420 thereof. The heat treatment of the coating film containing the first element 42a and the base member 41 may be performed at a temperature of 300° C. to 1200° C. in the air, for example. The base member 41 need not contain the first element 42a. The polycrystalline film 42 may contain an amount of the first element 42a on the side far from the base member 41 that is larger than that on the side closer to the base member 41.

The coating layer 43 is located on the polycrystalline film 42. The coating layer 43 coats the polycrystalline film 42 of the electrically conductive member 18 over the thickness direction T and the length direction L of the cell 1 in the cross section of FIG. 4B. The coating layer 43 contains an element different from that of the polycrystalline film 42. The coating layer 43 has electrical conductivity, for example. The coating layer 43 is located between the polycrystalline film 42 and the oxidizing atmosphere, which can suppress the release of chromium contained in the base member 41 and/or the polycrystalline film 42, for example. Therefore, the durability of the electrically conductive member 18 is improved, so that the durability of the cell 1 can be improved.

The coating layer 43 may contain oxide containing, for example, Mn (manganese) and Co (cobalt). The coating layer 43 may be porous. The coating layer 43 may have a structure in which different elements are stacked.

### Module

A module according to the embodiment of the present disclosure using the cell stack device 10 described above will be described next with reference to FIG. 5. FIG. 5 is an exterior perspective view illustrating a module according to the first embodiment. FIG. 5 illustrates a state in which front and rear faces that are part of a storage container 101 are removed and the cell stack device 10 of the fuel cell housed in the above container is taken out rearward.

As illustrated in FIG. 5, a module 100 includes the storage container 101, and the cell stack device 10 housed in the storage container 101. The reformer 102 is located above the cell stack device 10.

The reformer 102 generates a fuel gas by reforming a raw fuel such as natural gas and kerosene and supplies the fuel gas to the cell 1. The raw fuel is supplied to the reformer 102 through a raw fuel supply pipe 103. Note that the reformer 102 may include a vaporizing unit 102a for vaporizing water and a reforming unit 102b. The reforming unit 102b includes a reforming catalyst (not illustrated) to reform the raw fuel into a fuel gas. The reformer 102 can perform steam-reforming, which is a highly efficient reformation reaction.

The fuel gas generated by the reformer 102 is supplied to the gas-flow passages 2a of the cell 1 (see FIG. 1A) through the gas circulation pipe 20, the gas tank 16, and the support member 14.

In the module 100 having the configuration mentioned above, the temperature in the module 100 during normal power generation is from about 500° C. to 1000° C. due to combustion of gas and power generation by the cell 1.

In the module 100, as described above, the cell stack device 10 including the plurality of cells 1 that suppress the degradation of the power generation performance is housed, whereby the module 100 that suppresses the degradation of the power generation performance can be provided.

### Module Housing Device

FIG. 6 is an exploded perspective view illustrating an example of a module housing device according to the first embodiment. A module housing device 110 according to the present embodiment includes an external case 111, the module 100 illustrated in FIG. 5, and an auxiliary device (not illustrated). The auxiliary device operates the module 100. The module 100 and the auxiliary device are housed in the external case 111. Note that in FIG. 6, the configuration is partially omitted.

The external case 111 of the module housing device 110 illustrated in FIG. 6 includes a support 112 and an external plate 113. A dividing plate 114 vertically partitions the interior of the external case 111. The space above the dividing plate 114 in the external case 111 is a module housing chamber 115 for housing the module 100. The space below the dividing plate 114 in the external case 111 is an auxiliary device housing chamber 116 for housing the auxiliary device operating the module 100. Note that in FIG. 6, the auxiliary device housed in the auxiliary device housing chamber 116 is omitted.

The dividing plate 114 includes an air circulation hole 117 for causing air in the auxiliary device housing chamber 116 to flow to the module housing chamber 115 side. The external plate 113 for forming the module housing chamber 115 includes an exhaust hole 118 for discharging air inside the module housing chamber 115.

In the module housing device 110, as described above, the module housing chamber 115 is mounted with the module 100 that suppresses the degradation of the power generation performance, whereby the module housing device 110 that suppresses the degradation of the power generation performance can be provided.

Note that, in the embodiment described above, the case where the support substrate of the hollow flat plate-shaped is used has been exemplified; however, the embodiment can also be applied to a cell stack device using a cylindrical support substrate.

### Second Embodiment

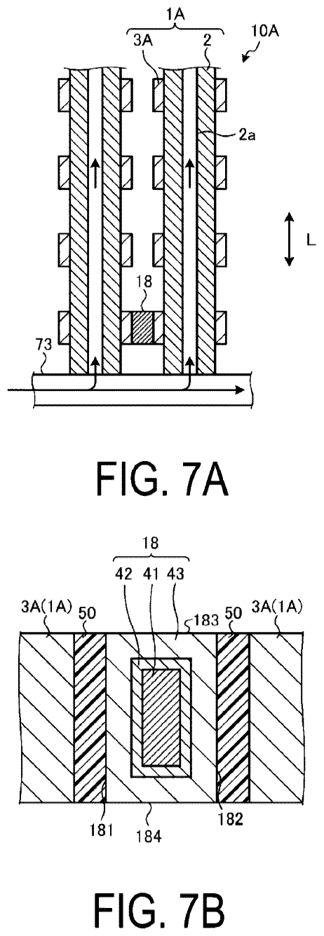

An electrochemical cell and an electrochemical cell device according to a second embodiment will be described with reference to FIGS. 7A and 7B.

In the embodiment described above, a so-called “vertically striped type” electrochemical cell device, in which only one element portion including the fuel electrode, the solid electrolyte layer, and the air electrode is provided on the surface of the support substrate, is exemplified. However, the present disclosure can be applied to an electrochemical cell device with an array of so-called “horizontally striped type” electrochemical cells, in which a plurality of element portions are provided at mutually separated locations on the surface of the support substrate and adjacent element portions are electrically connected to each other.

FIG. 7A is a cross-sectional view illustrating an example of an electrochemical cell according to the second embodiment. In a cell stack device 10A, a plurality of cells 1A extend in the length direction L from a pipe 73 through which a fuel gas flows. The cell 1A includes a plurality of element portions 3A on the support substrate 2. The gas-flow passage 2a, through which a gas from the pipe 73 flows, is provided inside the support substrate 2. The element portions 3A each on the support substrate 2 are electrically connected by a connection layer (not illustrated). The plurality of cells 1A are electrically connected to each other via the electrically conductive member 18. The electrically conductive member 18 is located between the element portions 3A each included in each cell 1A and electrically connects adjacent cells 1A to each other. Specifically, the electrically conductive member 18 electrically connects a current collector or an interconnector electrically connected to an air electrode of the element portion 3A of one cell 1A of the adjacent cells 1A to a current collector or an interconnector electrically connected to a fuel electrode of the element portion 3A of the other cell 1A of the adjacent cells 1A.

FIG. 7B is an enlarged cross-sectional view of the electrically conductive member according to the second embodiment. As illustrated in FIG. 7B, the electrically conductive member 18 is bonded, via the bonding material 50, to each of the cells 1A adjacent to each other. The electrically conductive member 18 has the first surface 181 and the second surface 182 that face each other with the base member 41 interposed therebetween. The electrically conductive member 18 has the third surfaces 183 and 184 that connect the first surface 181 and the second surface 182.

The electrically conductive member 18 is bonded to each of the cells 1A via the bonding material 50. The bonding material 50 is located between the first surface 181 of the electrically conductive member 18 and the element portion 3A of one cell 1A and between the second surface 182 of the electrically conductive member 18 and the element portion 3A of the other cell 1A, and bonds each of a pair of the cells 1A facing each other with the electrically conductive member 18 interposed therebetween and the electrically conductive member 18. The third surfaces 183 and 184 are exposed to, for example, an oxidizing atmosphere such as air.

The electrically conductive member 18 includes the base member 41, the polycrystalline film 42, and the coating layer 43. Each part constituting the electrically conductive member 18 can be made of, for example, a material such as that of the electrically conductive member 18 according to the first embodiment described above.

The polycrystalline film 42 is located on the base member 41. The polycrystalline film 42 is located between the base member 41 and the coating layer 43. The polycrystalline film 42 includes the plurality of chromium oxide particles 421 and the grain boundary phase 420 located among the plurality of chromium oxide particles 421 (see FIG. 4C). The polycrystalline film 42 contains the first element 42a having a first ionization energy and a free energy of formation of oxide per mole of oxygen that are smaller than those of chromium. The grain boundary phase 420 has a content percentage of the first element 42a that is higher than that of the plurality of chromium oxide particles 421.

As described above, since the electrically conductive member 18 includes the first element 42a at a specific position of the polycrystalline film 42, the polycrystalline film 42 is less likely to be increased in thickness and the electrical resistivity of the polycrystalline film 42 is less likely to be increased, and thus the internal resistance of the electrically conductive member 18 is less likely to be increased. This can suppress the degradation of the power generation performance of the cell 1A, and thus suppress the degradation of the power generation performance of the cell stack device 10A. Since the polycrystalline film 42 contains the first element 42a, for example, chromium in the polycrystalline film 42 may be unlikely to evaporate from the surface of the polycrystalline film 42 into an oxidizing atmosphere such as air.

### Third Embodiment

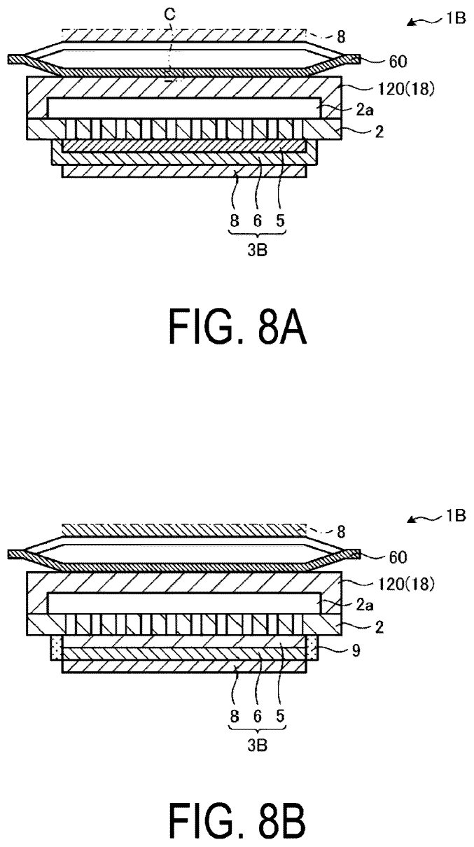

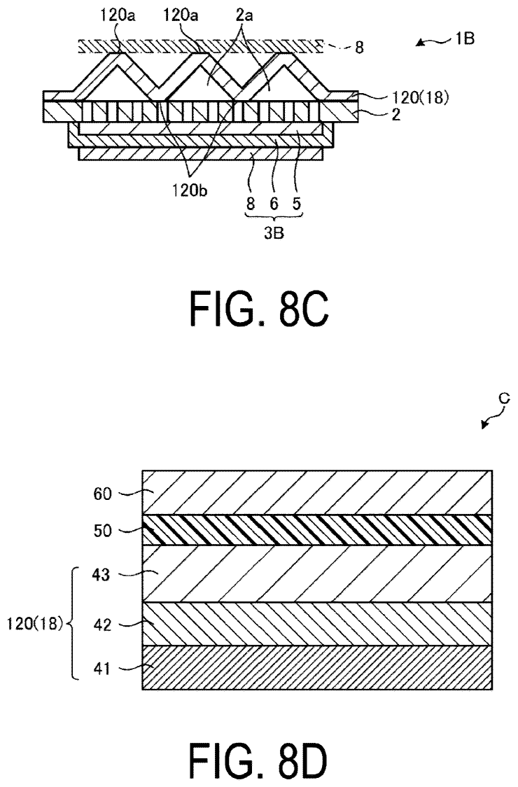

FIG. 8A is a horizontal cross-sectional view illustrating an example of an electrochemical cell according to a third embodiment. FIGS. 8B and 8C are horizontal cross-sectional views illustrating other examples of the electrochemical cell according to the third embodiment. FIG. 8D is an enlarged view of a region C illustrated in FIG. 8A. Note that FIG. 8D can also be applied to the examples in FIGS. 8B and 8C.

As illustrated in FIGS. 8A to 8C, a cell 1B includes an element portion 3B in which the fuel electrode 5, the solid electrolyte layer 6, and the air electrode 8 are stacked, and the support substrate 2. The support substrate 2 includes through holes or fine holes at a portion in contact with the fuel electrode 5 of the element portion 3B, and is provided with a member 120 located outside the gas-flow passage 2a. The support substrate 2 allows gas to flow between the gas-flow passage 2a and the element portion 3B. The support substrate 2 may be made of, for example, one or more metal plates. A material of the metal plate may contain chromium. The metal plate may include an electrically conductive coating layer. The support substrate 2 is an electrically conductive member electrically connecting the adjacent cells 1B to each other. The element portion 3B may be directly formed on the support substrate 2 or may be bonded to the support substrate 2 with a bonding material.

In the example illustrated in FIG. 8A, the side surface of the fuel electrode 5 is coated with the solid electrolyte layer 6 to hermetically seal the gas-flow passage 2a through which the fuel gas flows. As illustrated in FIG. 8B, the side surface of the fuel electrode 5 may be coated and sealed with a dense sealing material 9. The sealing material 9 coating the side surface of the fuel electrode 5 may have electrical insulation properties. As a material of the sealing material 9, glass or a ceramic may be used, for example.

The gas-flow passage 2a of the support substrate 2 may be formed by the member 120 having unevenness as illustrated in FIG. 8C.

In the third embodiment, the member 120 is bonded to the air electrode 8 of the other of the adjacent cells 1B via another electrically conductive member such as an inter-cell connecting member 60 and the bonding material 50. Note that the member 120 may be in direct contact with the air electrode 8 of the other cell 1B without the other electrically conductive members interposed therebetween.

As illustrated in FIG. 8D, the member 120 includes the base member 41, the polycrystalline film 42, and the coating layer 43. Each part constituting the member 120 can be made of, for example, a material as used for the electrically conductive member 18 described above. Although not illustrated in detail, the inter-cell connecting member 60 and/or the support substrate 2 may also be the electrically conductive member such as the member 120 including the base member 41, the polycrystalline film 42, and the coating layer 43.

The polycrystalline film 42 is located between the base member 40 and the other of the adjacent cells 1B. The polycrystalline film 42 includes the plurality of chromium oxide particles 421 and the grain boundary phase 420 located among the plurality of chromium oxide particles 421 (see FIG. 4C). The polycrystalline film 42 contains the first element 42a having a first ionization energy and a free energy of formation of oxide per mole of oxygen that are smaller than those of chromium. The grain boundary phase 420 has a content percentage of the first element 42a that is higher than that of the plurality of chromium oxide particles 421.

As described above, since the member 120 includes the specific polycrystalline film 42 described above, the polycrystalline film 42 is less likely to be increased in thickness, and thus the internal resistance of the member 120 is less likely to be increased. This suppresses the degradation of the power generation performance of the cell 1B, which can suppress the degradation of the power generation performance of the electrochemical cell device. Since the polycrystalline film 42 contains the first element 42a, for example, chromium in the polycrystalline film 42 may be unlikely to evaporate from the surface of the polycrystalline film 42 into an oxidizing atmosphere such as air.

Note that in the present embodiment, the polycrystalline film 42 may be formed only on a part of the member 120. For example, in the example illustrated in FIG. 8C, the polycrystalline film 42 and the coating layer 43 may be provided only on a first portion 120a facing the air electrode 8 of the other cell 1B, and only the polycrystalline film 42 may be provided on a second portion 120b facing the support substrate 2. The support substrate 2 may be provided with the polycrystalline film 42 at a portion facing the fuel electrode 5 of the cell 1B.

### Fourth Embodiment

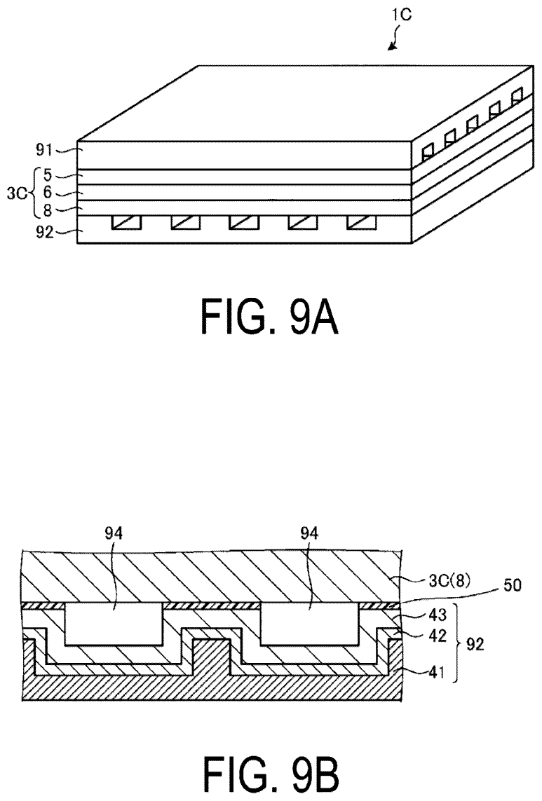

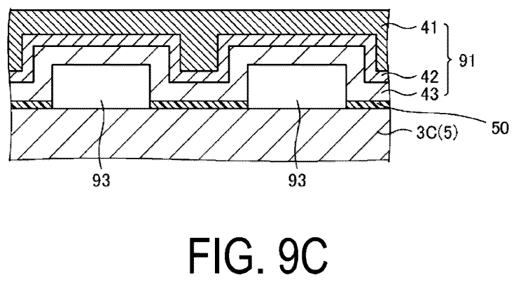

FIG. 9A is a perspective view illustrating an electrochemical cell according to a fourth embodiment. FIGS. 9B and 9C are partial cross-sectional views of the electrochemical cell illustrated in FIG. 9A.

As illustrated in FIG. 9A, a cell 1C includes an element portion 3C in which the fuel electrode 5, the solid electrolyte layer 6, and the air electrode 8 are stacked. In a cell stack device in which a plurality of flat plate cells are stacked, for example, a plurality of the cells 1C are electrically connected by electrically conductive members 91 and 92, which are metal layers adjacent to each other. The electrically conductive members 91 and 92 electrically connect adjacent cells 1C to each other, and each include gas-flow passages for supplying gas to the fuel electrode 5 or the air electrode 8.

As illustrated in FIG. 9B, in the present embodiment, the electrically conductive member 92 includes gas-flow passages 94 for supplying an oxygen-containing gas to the air electrode 8. The electrically conductive member 92 is bonded to the element portion 3C (air electrode 8) via the bonding material 50. Note that the electrically conductive member 92 may be in direct contact with the element portion 3C without the bonding material 50 interposed therebetween. In other words, in the present embodiment, the electrically conductive member 92 may be directly connected to the element portion 3C without using the bonding material 50.

The electrically conductive member 92 includes the base member 41, the polycrystalline film 42, and the coating layer 43. Each part constituting the electrically conductive member 92 can be made of, for example, a material as used for the electrically conductive member 18 described above.

The polycrystalline film 42 is located on the base member 41. The polycrystalline film 42 is located between the base member 41 and the coating layer 43. The polycrystalline film 42 includes the plurality of chromium oxide particles 421 and the grain boundary phase 420 located among the plurality of chromium oxide particles 421 (see FIG. 4C). The polycrystalline film 42 contains the first element 42a having a first ionization energy and a free energy of formation of oxide per mole of oxygen that are smaller than those of chromium. The grain boundary phase 420 has a content percentage of the first element 42a that is higher than that of the plurality of chromium oxide particles 421.

As such, since the electrically conductive member 92 includes the specific polycrystalline film 42 as described above, the polycrystalline film 42 is less likely to be increased in thickness, and thus the internal resistance of the electrically conductive member 92 is less likely to be increased. This can suppress the degradation of the power generation performance of the cell 1C, and thus suppress the degradation of the power generation performance of the cell stack device including the plurality of cells 1C. Since the polycrystalline film 42 contains the first element 42a, for example, chromium in the polycrystalline film 42 may become unlikely to evaporate from the surface of the polycrystalline film 42 into an oxidizing atmosphere such as air.

As illustrated in FIG. 9C, the electrically conductive member 91 includes gas-flow passages 93 for supplying fuel gas to the fuel electrode 5. The electrically conductive member 91 is bonded to the element portion 3C (fuel electrode 5) via the bonding material 50. Note that the electrically conductive member 91 may be in direct contact with the element portion 3C without the bonding material 50 interposed therebetween. In other words, the electrically conductive member 91 may be directly connected to the element portion 3C without using the bonding material 50.

The electrically conductive member 91 includes the base member 41, the polycrystalline film 42, and the coating layer 43. Each part constituting the electrically conductive member 91 can be made of, for example, a material as used for the electrically conductive member 92 (electrically conductive member 18) mentioned above. The electrically conductive member 91 need not include the coating layer 43.

The polycrystalline film 42 is located on the base member 41. When the electrically conductive member 91 includes the coating layer 43, the polycrystalline film 42 is located between the base member 41 and the coating layer 43. The polycrystalline film 42 includes the plurality of chromium oxide particles 421 and the grain boundary phase 420 located among the plurality of chromium oxide particles 421 (see FIG. 4C). The polycrystalline film 42 contains the first element 42a having a first ionization energy and a free energy of formation of oxide per mole of oxygen that are smaller than those of chromium. The grain boundary phase 420 has a content percentage of the first element 42a that is higher than that of the plurality of chromium oxide particles 421.

As described above, since the electrically conductive member 91 includes the specific polycrystalline film 42, the polycrystalline film 42 is less likely to be increased in thickness, and thus the internal resistance of the electrically conductive member 91 is less likely to be increased. This can suppress the degradation of the power generation performance of the cell 1C, and thus suppress the degradation of the power generation performance of the electrochemical cell device including the plurality of cells 1C.

Note that although the electrically conductive members 91 and 92 are described as including the coating layer 43 with reference to FIG. 9B and FIG. 9C, one or both of the electrically conductive members 91 and 92 need not include the coating layer 43. That is, the polycrystalline film 42 may be exposed to the gas supplied to the fuel electrode 5 or the air electrode 8. In the present embodiment, both of the electrically conductive members 91 and 92 are described as including the polycrystalline film 42, but one of the electrically conductive members 91 and 92 need not include the polycrystalline film 42.

### Other Embodiments

An electrochemical cell device according to other embodiments will be described.

In the above embodiments, a fuel cell, a fuel cell stack device, a fuel cell module, and a fuel cell device are illustrated as examples of the “electrochemical cell”, the “electrochemical cell device”, the “module”, and the “module housing device”; and they may also be an electrolytic cell, an electrolytic cell stack device, an electrolytic module, and an electrolytic device, respectively, as other examples. The electrolytic cell includes a hydrogen electrode serving as a first electrode and an oxygen electrode serving as a second electrode and decomposes water vapor into hydrogen and oxygen by being supplied with electrical power. Although an oxide ion conductor or a hydrogen ion conductor is described as an example of the electrolyte material of the electrochemical cell in the above embodiment, the electrolyte material may be a hydroxide ion conductor. The electrolytic cell, electrolytic cell stack device, electrolytic module, and electrolytic device discussed above can have electrolytic performance.

While the present disclosure has been described in detail, the present disclosure is not limited to the aforementioned embodiments, and various changes, improvements, and the like can be made without departing from the gist of the present disclosure.

As mentioned above, the electrically conductive member 18 according to the embodiment includes the base member 41 and the polycrystalline film 42 located on the base member 41. The base member 41 contains chromium. The polycrystalline film 42 includes the plurality of chromium oxide particles 421 and the grain boundary phase 420 located among the plurality of chromium oxide particles 421. The polycrystalline film 42 contains the first element 42a having a first ionization energy and a free energy of formation of oxide per mole of oxygen that are smaller than those of chromium. The grain boundary phase 420 has a content percentage of the first element 42a that is higher than that of the plurality of chromium oxide particles 421. This can reduce the increase in the internal resistance of the electrically conductive member 18.

The electrochemical cell according to the embodiment includes the element portion 3 and the electrically conductive member 18 mentioned above. The electrically conductive member 18 is connected to the element portion 3. Thus, the electrochemical cell can be provided that suppresses the degradation of performance due to the increase in the internal resistance.

The electrochemical cell device according to the present embodiment includes the cell stack 11 including the electrochemical cell described above. Thus, the electrochemical cell device can be provided that suppresses the degradation of performance due to the increase in the internal resistance.

The module 100 according to the embodiment includes the electrochemical cell device described above, and the storage container 101 that houses the electrochemical cell device. This can provide the module 100 that suppresses the degradation of performance due to the increase in the internal resistance.

The module housing device 110 according to the embodiment includes the module 100 described above, the auxiliary device to operate the module 100, and the external case housing the module 100 and the auxiliary device. This can provide the module housing device 110 that suppresses the degradation of performance due to the increase in the internal resistance.

Note that the embodiments disclosed herein are exemplary in all respects and not restrictive. The aforementioned embodiments can be embodied in a variety of forms. The aforementioned embodiments may be omitted, replaced, or changed in various forms without departing from the scope of the appended claims and the purpose thereof.

### REFERENCE SIGNS

1, 1A, 1B, 1C Cell
3, 3A, 3B, 3C Element portion
5 Fuel electrode
6 Solid electrolyte layer
7 Intermediate layer
8 Air electrode
9 Cell stack device
11 Cell stack
12 Fixing member
13 Fixing material
14 Support member
15 Support body
16 Gas tank
17 End current collection member
18 Electrically conductive member
41 Base member
42 Polycrystalline film
43 Coating layer
100 Module
110 Module housing device

1. An electrically conductive member comprising:
a base member containing chromium; and
a polycrystalline film located on the base member, the polycrystalline film comprising a plurality of chromium oxide particles and a grain boundary phase located among the plurality of chromium oxide particles,
wherein the polycrystalline film contains a first element having a first ionization energy and a free energy of formation of oxide per mole of oxygen that are smaller than those of chromium, and
the grain boundary phase has a content percentage of the first element that is higher than that of the plurality of chromium oxide particles.

2. The electrically conductive member according to claim 1,
wherein the base member has a content percentage of the first element that is smaller than that of the polycrystalline film.

3. The electrically conductive member according to claim 1,
wherein the first element is one or more elements selected from the group consisting of Ce, Eu, Pr, and Zr.

4. The electrically conductive member according to claim 1,
wherein the plurality of chromium oxide particles contain, at least one chromium oxide particle having at least one first particle therein, the first particle containing the first element.

5. The electrically conductive member according to claim 1, further comprising an oxide of the first element located on the polycrystalline film.

6. The electrically conductive member according to claim 1, further comprising an electrically conductive coating layer located on the polycrystalline film.

7. An electrochemical cell comprising:
an element portion; and
the electrically conductive member according to claim 1, the electrically conductive member being connected to the element portion.

8. An electrochemical cell device comprising
a cell stack comprising the electrochemical cell according to claim 7.

9. A module comprising:
the electrochemical cell device according to claim 8; and
a storage container housing the electrochemical cell device.

10. A module housing device comprising:
the module according to claim 9;
an auxiliary device operating the module; and
an external case housing the module and the auxiliary device.
